(19) United States
(12) Patent Application Publication
(10) Pub. No.: US 2010/0057358 A1
(43) Pub. Date: Mar. 4, 2010

(54) PORTABLE GPS MAP DEVICE FOR COMMERCIAL VEHICLE INDUSTRY

(75) Inventors: Marleen Karen Winer, Boston, MA (US); Edward Friedman, Boston, MA (US)

Correspondence Address: RISSMAN HENDRICKS & OLIVERIO, LLP, 100 Cambridge Street, Suite 2101, BOSTON, MA, 02114, US

(73) Assignee: TeleType Co., Inc., Boston, MA (US)

(21) Appl. No.: 12/211,460

(22) Filed: Sep. 16, 2008

Related U.S. Application Data
(63) Continuation-in-part of application No. 12/199,815, filed on Aug. 28, 2008.

(51) Int. Cl. G01C 21/36

(52) U.S. Cl. 701/210; 701/200; 701/209

(57) ABSTRACT

Apparatus for determining a route for a road vehicle for a user comprising:
a database of information pertaining to roads, the information comprising geographic data that includes map, location and configuration data for the roads, the information further comprising data indicative of a plurality of road characteristics or limits that pertain to the roads;
a program having a first operation that compares a multiplicity of selected characteristics or limits of the road vehicle to the data indicative of the plurality of road characteristics or limits contained within the database and a second operation that computes one or more authorized road routes for the road vehicle;
wherein the program includes instructions that compute one or more unauthorized road routes or portions of unauthorized road routes having road characteristics that are not complementary to or do not match the selected characteristics or limits of the road vehicle.

### RELATED APPLICATIONS

This application is a continuation and/or continuation-in-part of and claims the benefit of priority under 35 U.S.C. Section 119 and/or 120 to U.S. patent application Ser. No. 12/199,815 filed Aug. 28, 2008, the disclosure of which is incorporated herein in its entirety by reference as if fully set forth herein.

### FIELD OF THE INVENTION

The present invention relates to the field of vehicle routing systems. More particularly the invention relates to a GPS map navigation and routing device for the commercial vehicle industry that allows dynamic change of road display on a moving map device and gives route guidance and prepares road route data in a map database based on the physical criteria and content of the vehicle.

### BACKGROUND OF THE INVENTION

The global positioning system comprises twenty-four navigational satellites in high orbit about 20,000 km about the earth. The satellites transmit precise time and position information continuously and the transmissions can be received anywhere in the world by a suitable GPS receiver. By processing the information the transmission of the GPS receiver can determine its exact position fix via ranging. Each satellite transmits almanac and ephemeris data components. The almanac data components contain information on the location and operational status of satellites in the system. The ephemeris data components comprise the precise satellite positioning information that is used for ranging. At present the global positioning system is used for navigation between locations identified by an address given by their longitude and latitude. In other words the GPS system conventionally operates using address positioning whereby, in effect, to navigate from a first point to a second point the absolute addresses of each point must be specified. Whilst address oriented positioning is often suitable for machine to machine communications it is less preferable in person to person or machine to person communication as it requires the person involved to know his or her absolute position.

Vehicle information systems have been developed that provide various types of information to operators of those vehicles. These systems use the on-board map to plan a route from a starting point to a destination, which is specified by the operator of the vehicle. In some systems the operator inputs the desired destination (and the current location, if required by the system) by entering a spelling of the destination. Once the operator inputs the destination, the system plans a route along the road network to the destination. Once the route is planned, the operator is guided by the system along the route. In GPS, multiple satellites emit signals that allow an in-vehicle GPS receiver to estimate its absolute location.

The relevant prior art methods, which will deal with vehicle information systems, are as follows:

ALK technologies, www.alk.com, is a product marketed under the name Co-Pilot Truck for laptops. This product is a software program that is loadable onto a laptop computer. It uses a fixed/static set of vehicle parameters peculiar to a certain industry standard sized and kind of semi-trailer truck and a database of road condition data to which the static set of truck parameters is compared to generate a proposed road route in which the selected route of roads meet the fixed set of parameters. The map or route displayed on the user interface/monitor does not indicate roads that do not meet the parameters of the vehicle.

U.S. Pat. No. 5,917,435 discloses a navigation apparatus for vehicles which comprises a GPS receiver connected to a GPS antenna, a gyro sensor, a vehicle signal processing circuit for processing vehicle signals such as a vehicle speed signal, a CD unit for driving a CD-ROM containing map information, a display unit for displaying a map, and an ECU for controlling the entire operation, wherein at least the CD unit, the display unit and the ECU are disposed within a detachable unit which can be detachably installed in a vehicle.

U.S. Pat. No. 5,802,492 claims a Computer Aided Routing and Positioning System (CARPS) that determines a route along selected waypoints that include a travel origin and a travel destination and intermediate waypoints there between. The selected waypoints may be uploaded to or downloaded from various geocoding devices that utilize the Global Positioning System (GPS).

U.S. Pat. No. 6,418,375 describes a method of routing using an offboard navigation system for motor vehicles, in which road points, at which there is a road junction, and also the road distance between adjacent road points on a calculated route are stored in a memory element in the vehicle. Preferably, only those road points which are also turnoff points are stored. The distance from the next turnoff point at which a turnoff maneuver is to be effected is determined by comparing the distance covered since the last turnoff point with a stored value for the road distance between the adjacent turnoff points.

U.S. Pat. No. 6,321,158 details an Integrated Routing/Mapping Information System (IRMIS) that links desktop personal computer cartographic applications to one or more handheld organizer, personal digital assistant (PDA) or “palmtop” devices.

U.S. Pat. No. 6,268,825 claims a navigation control ECU that gives normal guidance to the driver of a vehicle based on the present location of the vehicle as determined from a D-GPS and map data from a map database. A map database detailing device obtains detailed data on the shape of a road from the detected valued of a yaw rate sensor, an acceleration sensor, and a vehicle speed sensor and the data of the map database, and stores the detailed data in a detailed map database. A vehicle control ECU evaluates the traveling stability of the vehicle at a curve and controls the deceleration, etc., of the vehicle by utilizing the detailed road shape data in the database.

U.S. Pat. No. 6,628,233 describes a vehicle information system which includes an in-vehicle system and a centralized server system. The in-vehicle system communicates with the server system using a wireless communication link, such as over a cellular telephone system. A position system, such as a set of GPS satellites, provides positioning signals that are used by the in-vehicle systems, and optionally by the centralized server system to increase the accuracy of position estimates. In one version of the system, an operator specifies a destination to an in-vehicle system which validates the destination. The in-vehicle system transmits specification of the destination to a server system at the centralized server. The server system computes a route to the destination and transmits the computed route to the in-vehicle system. The in-vehicle system guides the operator along the route. If the in-vehicle system detects that the vehicle has deviated from the planned route, it replans a new route to the destination using an in-vehicle map database.

U.S. Pat. No. 6,762,696 discloses a routing display for a navigation system in a road vehicle in the form of an electro-optical display can be driven by a routing computer and uses symbols to display a direction of current travel and a direction which is to be taken after a turn-off point relative to one another. The sizes of the two symbols relative to one another is changed such that the relative size of the symbol marking the direction which is to be taken after the turn-off point increases as the turn-off point is approached. Accordingly, when the driver looks at the routing display, he is given the visual impression that he is approaching the turn-off point.

U.S. Pat. No. 7,272,497 describes a vehicle navigation system (e.g., GPS) with multi-use display generator that provides for the switching of a displayed image from a navigational based image to a non-navigational image such as a favorite photo. This versatility allows for the user of a vehicle navigation to avoid having to look at a boring display of map images and instead view more desirable non-navigation images such as full 100% displays of a favorite photo shot.

U.S. Pat. No. 7,231,297 claims a navigation system which guides a subject vehicle to a destination by displaying at a display monitor an arrow indicating the direction of the next turn instead of displaying a map includes a decision-making device that makes a decision as to whether or not the subject vehicle is currently located on a recommended route to a destination set in advance based upon the current position of the subject vehicle, an abridged map generating device that generates an abridged map by abridging a map based upon map data and a display control device that displays at the display monitor the abridged map and the subject vehicle position if the decision-making device determines that the subject vehicle is not currently located on the recommended route.

However the route is typically planned by the above vehicle information systems to provide a shortest distance or to try to provide the shortest travel time and not based on the best route as per the physical criteria and content of a vehicle. Local and Federal authorities require certain type of vehicles with specific dimensions and content not to travel via certain streets. Presently the only way for a vehicle operator to know if he is located on a street where he permitted or not permitted to be is by reading the signs along the road at which point it might already be too late. Also some of the signs are not visible at night or in inclement weather such as snow or fog. Electronic devices that presently display moving maps inside vehicles display roads only according to their attributes such as the width of the lane or category of the street such as “Local Street” or “State Road” or “Interstate Freeway.” These roads may or may not be suitable for commercial traffic.

Further the above vehicle information systems do not have color of roads changing with parameters specified.

Further the present invention differs from the prior art in that in one embodiment it provides one route that precisely fits the need of the truck driver based on the characteristics of the vehicle including size, weight, height, and hazmat considerations, rather than a series of possible routes. In other embodiments the present invention provides a map to the user of alternative allowable or authorized roads that meet the characteristics of the vehicle.

### SUMMARY OF THE INVENTION

This invention may be summarized, at least in part, with reference to its objects.

Foremost primary object of this invention is to provide a GPS map navigation device that optimizes needed navigation for a commercial vehicle based on the input and use of the physical characteristics, limits, criteria and/or content of the vehicle.

Another object of the present invention is to provide a GPS map navigation device that plans a road route to a selected destination taking into consideration, size, weight, hauling contents of the road vehicle, among other considerations.

Yet another object of the present invention is to provide a GPS map navigation device that allows dynamic change of road display on moving map device for special use vehicles.

A further object of the present invention is to provide a GPS map navigation device where each route is designated by a color or texture or other visual identifier format such as shading, numbering, lettering, symbol, shape, size, brightness, contrast, font, style, outlining and the like to indicate to the driver if the road is suitable for travel and/or if the road is not suitable for travel by a vehicle having certain known parameters, characteristics or limits that are input to a program contained within the device. A route suitable for travel is assigned one visual identifier format (e.g. the color yellow) and a route not suitable for travel is assigned another different visual identifier format (e.g. the color pink).

Additional objects, advantages and novel features of the invention will be set forth in part in the description which follows, and in part will become apparent to those skilled in the art upon examination of the following, or may be learned by practice of the invention.

### BRIEF DESCRIPTION OF THE DRAWINGS

These and other objects and advantages and features of the present invention will be more readily apparent when considered in reference to the following description and when taken in conjunction with the accompanying drawings listed below wherein:

FIGS. 1 through 11 show schematic images of examples of a display shown on a monitor of a user interface for communicating data between a user and a computer that computes, generates and displays the road routes, user prompts for inputs and other information in an apparatus according to the invention.

FIG. 1 is an image of a screen displayed on a user interface for initially selecting a parameter for establishing the selection of a route to be used for car navigation in an apparatus according to the invention;

FIG. 2 is an image of an example of a screen display of a selected set of authorized streets and roads available for navigation by a road vehicle within a select vicinity by use of an apparatus according to the invention;

FIG. 3 is an example of an image of a screen display showing group of parameters/characteristics/limits for a select road vehicle for input to a program for use in an apparatus according to the invention, the display showing as an example the input of road vehicle characteristics for a vehicle that is 12 feet high, 52 feet/10 inches long and weighs 4,000 pounds;

FIG. 4 is an example of an image of a street map generated by an apparatus according to the invention showing an allowed or authorized route that meets or is complementary to or matches the characteristics/parameters that were input by the user in FIG. 3, the allowed or authorized road route portions being displayed and designated on the monitor in a unique color or other visual identifier as A and the unauthorized or not allowable road route portions of the map being displayed and designated on the monitor in another different monitor color or other visual identifier as NA;

FIG. 5 is an example of an image of a screen display for selecting a group of characteristics/parameters for a select road vehicle for input to a program for use in an apparatus according to the invention, the display showing as an example the input of road vehicle characteristics/parameters for a vehicle that is 13 feet/6 inches high, 53 feet long and weighs 80,000 pounds;

FIG. 6 is an image of a street map generated by a device according to the inventions showing an allowed or authorized road route that meets or is complementary to or matches the parameters that were input by the user in FIG. 5, the allowed or authorized route being displayed and designated on the monitor in a unique color or other visual identifier labeled as A and the not allowed or unauthorized road route portions being displayed and designated in another different unique color or other visual identifier labeled NA;

FIG. 7 is an example of an image of a screen display generated by a device according to the invention, the image presenting an Information menu having user activatable buttons for retrieving selected information about the allowed or authorized route portions;

FIG. 8 is an example of an image of a screen displaying the details of the restrictions of the displayed unauthorized road route portions in particular pertaining to weight limitations, such details being readily retrievable for display by use of the Information menu;

FIG. 9 is an example of an image of a screen displaying informational detail of the displayed unauthorized road route restrictions particularly pertaining to Hazardous Materials, such details being readily retrievable for display by use of the Information menu;

FIG. 10 is an example of an image of a screen displaying a perspective view of a map with road route portions that are determined to be authorized for the vehicle characteristics/parameters of FIG. 5 displayed in one color or other visual identifier labeled as A and road route portions that are determined to be not authorized or allowable displayed in another different selected color or other selected visual identifier labeled as NA; and

FIG. 11 is an example of an image of a screen display showing a map of a road route in the vicinity of the actual position of the vehicle, showing those portions of the upcoming road route portion in a selected color or other visual identifier that is indicative of a selected slope or gradient to the road that is not authorized for the characteristics/parameters of the road vehicle.

### DETAILED DESCRIPTION OF THE INVENTION

The following description is presented to enable any person skilled in the art to make and use the invention, and is described with reference to particular embodiments.

For purposes herein the term “visual identifier” means any means of rendering or displaying information such as a graphic or picture or map or figure or script or lettering or word or icon or a portion of any of the forgoing on a monitor in a manner that distinguishes the displayed information to the human eye in a readily perceptible way from other information displayed on the monitor. Examples of visual identifiers are color, texture, shading, numbering, lettering, symbols, labeling, shape, size, brightness, contrast, font, style, outlining and the like.

For purposes herein selected “characteristics or limits of the road vehicle” means the maximum, minimum and/or actual values of one or more of all of the following: height, length, width and/or weight of the vehicle, ability of the engine to drive the vehicle having a selected weight including its cargo up an inclined road having a selected grade, the hazardous nature, if any, of the payload or cargo of the vehicle such as flammability, explosiveness, radioactivity, degree of odor/smell of the vehicle or its cargo, power of the engine, size of the engine, number of wheels of the vehicle, ability or non-ability to travel on non-paved road surfaces, turn radius capability, degree of tractability and inflation of the tires of the vehicle, degree of noise generation by the vehicle, degree of exhaust or emissions of the vehicle, type of fuel used by the vehicle and any other feature, characteristic, limit or parameter of the vehicle that may be proscribed or regulated or limited by a characteristic or parameter of a road.

For purposes herein the term road routes means a map or display of a single road or a combination of roads and segments thereof that make up a computed route or route as computed by the program described herein. In practice of the present invention, typically only a subset/segment of a computed road route or routes is displayed on the monitor that the user views depending of the field/focus of view selected by the user. Although a complete route of roads from the position of origin to the position of destination may be computed by the program of the invention and stored in memory, only a portion of such computed routes in the vicinity of the real time position of the vehicle is displayed on the monitor that is viewed by the user for ease of use purposes. As the real-time position of the vehicle changes, the portion/segment of the total computed road route that is displayed on the monitor changes dynamically to follow along with the position of the vehicle on the map of roads being displayed. Depending on the degree of focus on the real time position of the vehicle that the monitor is set on, a smaller or larger segment of the map of the total route will be displayed on the monitor to the user.

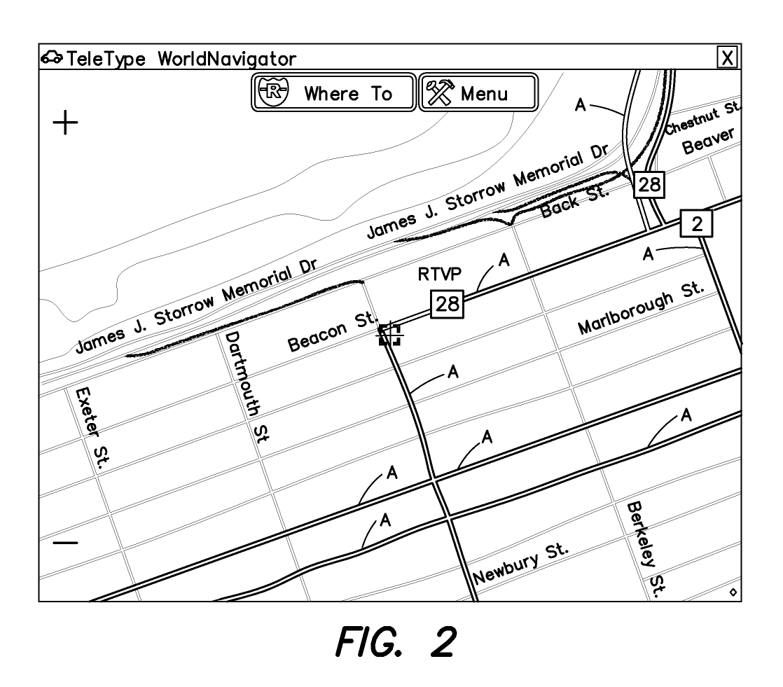

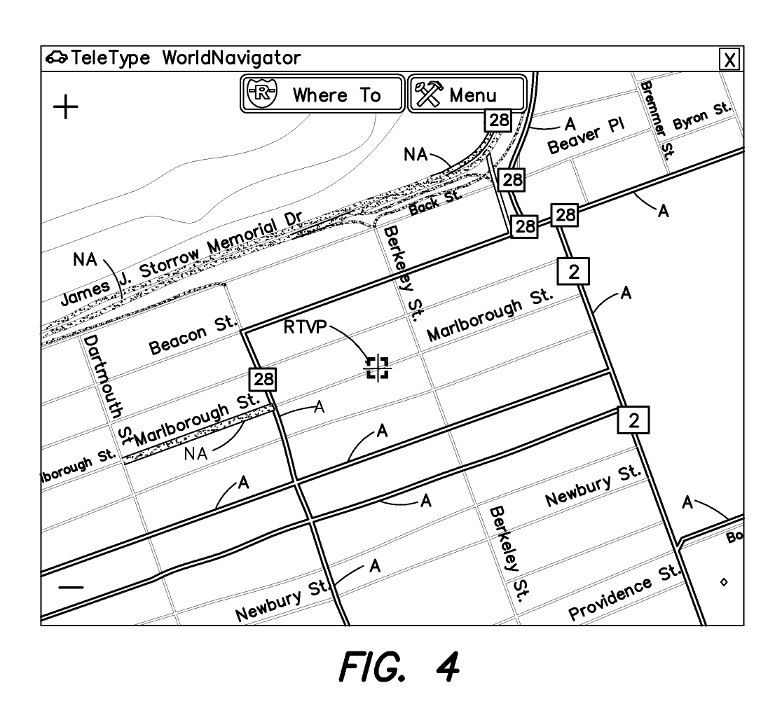

The real time position of the vehicle is preferably dynamically determined by a position determining device which is typically comprised of a conventional global positioning system that detects and determines the position on the surface of the earth of a thing such as a vehicle that has appropriate GPS signal receivers that receive GPS position signals from typically three or more satellites in orbit around the earth. The GPS signal receivers are typically mounted in, on or within the user interface that is mounted in the road vehicle but can also be separately and easily mounted and removed in a dedicated portable touch or non touch screen or laptop computer or other equivalent electronic signal receiving device that is mounted/disposed in the vehicle. The dynamically real time determined position of the vehicle is preferably automatically and dynamically input to the program that computes the road routes such that the real time position of the vehicle can be displayed on the same map that the computer program causes to be displayed on the monitor of the user interface. For example, as shown in FIGS. 2, 4, 6 and 10 the real time vehicle position, RTVP, is shown on the maps illustrated. The program preferably includes instructions to carry out the functions described in this paragraph.

The RTVP is also dynamically used by the program to select a segment of the computed road routes that is to be displayed on the monitor of the user interface, typically a segment that is within a selected vicinity or radius of the RTVP depending on the degree of focus or view of the map. The program preferably includes instructions to carry out the functions described in this paragraph.

The RTVP is also preferably dynamically used by the program to determine the size of the segment of the computed authorized road routes that are to be displayed on the monitor. The program preferably includes instructions to carry out the functions described in this paragraph.

The RTVP is also preferably used by the program to re-compute the authorized and unauthorized road routes and the maps thereof to be displayed if and when the vehicle deviates from a position on or along an authorized road route. The program preferably includes instructions to carry out the functions described in this paragraph.

In accordance with the invention, in one embodiment there is provided apparatus for determining a route for a road vehicle for a user comprising:

a database of information pertaining to roads, the information comprising geographic data that includes map, location and configuration data, the information further comprising data indicative of a plurality of road characteristics or limits (or parameters or criteria) that pertain to the roads, the plurality of characteristics or limits being selected from the group consisting of heights or clearances of bridges, load or weight limits, gradient or angle of road incline, obstructions, surface conditions, height, length and width of vehicle limits, number of vehicle wheel limits, size of engine limits, power of engine limits, nature of cargo or payload limits, direction of road limits, one way or two way direction limits, left or right hand turn limits, contour of road, ascent and descent limits, paved or not paved surfaces and limits prescribed by governmental rule or regulation;

a program having a first operation that compares a multiplicity (meaning at least two) of selected characteristics or limits of the road vehicle to the data indicative of the plurality of road characteristics or limits contained within the database and a second operation that computes one or more authorized road routes for the road vehicle, the second operation having instructions that use the comparison of the first operation to generate one or more authorized road routes having road characteristics that complement or match the selected characteristics or limits of the road vehicle;

a user interface mounted in the road vehicle and interconnected to the program, the user interface communicating data between the program and the user and including a monitor that displays the authorized road routes in one or more first selected visual identifiers to the user according to the instructions; and

a memory interconnected to the user interface and the program, the memory receiving an input of the multiplicity of selected characteristics or limits of the road vehicle from the user interface, the program receiving the multiplicity of selected characteristics or limits from the memory.

The program typically includes instructions that compute and display on the monitor one or more unauthorized (meaning not authorized or not allowed or allowable for the vehicle to travel on) road or portions of unauthorized road having road characteristics that are not complementary to or do not match the selected characteristics of the road vehicle, the unauthorized road routes or portions of unauthorized road routes being displayed according to the instructions in one or more second selected visual identifiers that are visually different from the first selected visual identifiers.

The apparatus typically further comprises a position determining device that determines the physical position of the vehicle on the road in, on or with respect to the geographic database of road configuration, location and map information.

The program instructions typically compute/generate the authorized road routes based on the input of a position of origin and a position of destination of the vehicle. The position of origin can be and is preferably input automatically and dynamically to the program by the position determining device. The position of origin can alternatively be manually input to the program instructions by the user by use of the user interface. The position of destination is typically manually input by the user by use of the user interface.

The user interface can include a mechanism for manually inputting data indicative of one or more of a position of destination, a position of origin and the selected physical characteristics of the road vehicle to the program.

The position determining device preferably includes an electronic signal receiver that receives electronic position signals from one or more satellites sending electronic position signals from outer space (meaning a position high above the surface of the earth) to the electronic signal receiver, the program being interconnected to the position determining device such that the program dynamically and automatically receives the electronic position signals and includes instructions that dynamically identify the position of the vehicle within the geographic data and display the identified position on the monitor.

The apparatus typically further comprises a computer having a processor for carrying out the first and second operations and memory for receiving and storing the data. The computer can be physically located remote from the road vehicle the user interface mounted in the vehicle communicating with the computer via a wireless electronic signal communicating apparatus that communicates signals between the user interface and computer including signals containing results of the first and second operations.

In a preferred embodiment, the apparatus comprises a dedicated portable computer integrated into a readily manually portable housing together with the user interface, the portable computer comprising a processor for carrying out the first and second operations and memory for receiving and storing the data and the portable housing being readily mountable in the road vehicle for ready visual and manual access by the user.

In such embodiments, the portable housing preferably includes a position determining device having a receiver that receives electronic position signals from one or more satellites that send electronic position signals from space, the program being interconnected to the position determining device such that the program dynamically and automatically receives the electronic position signals, the program including instructions for dynamically identifying the position of the vehicle within the geographic data of the database and displaying the identified position on the monitor.

In all embodiments, the program preferably includes instructions for computing one or more routes for the road vehicle based on a position of origin and a position of destination.

In one embodiment, the program includes instructions for computing one or more routes that minimize consumption of fuel by the road vehicle relative to other authorized/allowable routes.

The program can include instructions for displaying one or more components of a computed route in selected colors that are indicative of a selected characteristic of the computed route.

The program can include instructions for automatically re-computing one or more alternate authorized routes for the road vehicle when the road vehicle deviates from a position along the one or more road authorized routes computed in the second operation.

The program can include instructions for automatically re-computing one or more alternate authorized routes for the road vehicle when the road vehicle deviates from a position along the one or more authorized road routes computed in the second operation.

In another embodiment of the invention there is provided, an apparatus for determining a route for a road vehicle for a user comprising:

a database of information pertaining to roads, the information comprising geographic data that includes map, location and configuration data for the roads, the information further comprising data indicative of a plurality of road characteristics or limits that pertain to the roads, the plurality of characteristics or limits being selected from the group consisting of heights or clearances of bridges, load or weight limits, gradient or angle of road incline, obstructions, surface conditions, height, length and width of vehicle limits, number of vehicle wheel limits, size of engine limits, nature of cargo or payload limits, direction of road limits, one way or two way direction limits, left or right hand turn limits, contour of road, ascent and descent limits, paved or not paved surfaces and limits prescribed by governmental rule or regulation;

a program having a first operation that compares a multiplicity (meaning at least two) of selected characteristics or limits of the road vehicle to the data indicative of the plurality of road characteristics or limits contained within the database and a second operation that computes one or more authorized road routes for the road vehicle, the second operation having instructions that use the comparison of the first operation to generate one or more authorized road routes having road characteristics that complement or match the selected characteristics of the road vehicle; and

wherein the program includes instructions that compute one or more unauthorized road routes or portions of unauthorized road routes having road characteristics that are not complementary to or do not match the selected characteristics or limits of the road vehicle.

In such an embodiment, the apparatus typically further comprises a monitor interconnected to the program, the program including instructions that:

display the authorized road routes on the monitor in one or more first selected visual identifiers to the user; and,

display the unauthorized road routes or portions of unauthorized road routes on the monitor in one or more second selected visual identifiers that are visually different from the first selected visual identifiers.

Such an apparatus typically further comprises:

a user interface mounted in the road vehicle and interconnected to the program, the user interface communicating data between the program and the user; and

a memory interconnected to the user interface and the program, the memory receiving an input of the multiplicity of selected characteristics of the road vehicle from the user interface, the program receiving the multiplicity of selected characteristics from the memory.

In such an apparatus:

the user interface can be mounted in the road vehicle and interconnected to the program, the user interface including the monitor and communicating data between the program and the user via the monitor;

and have a memory interconnected to the user interface and the program, the memory receiving an input of the multiplicity of selected characteristics of the road vehicle from the user via the user interface, the program receiving the multiplicity of selected characteristics from the memory.

Such an apparatus typically further comprises a position determining device that includes an electronic signal receiver that receives electronic position signals from one or more satellites sending electronic position signals from space to the electronic signal receiver, the program being interconnected to the position determining device such that the program dynamically and automatically receives the electronic position signals and includes instructions that dynamically identify the position of the vehicle within the geographic data and displays the identified position on the monitor.

In such an apparatus the user interface preferably includes a device for manually inputting data indicative of one or more of a position of destination, a position of origin and the selected physical characteristics of the road vehicle to the program, the program including instructions for computing the one or more authorized and unauthorized routes based on one or more of the input position of destination, the input position of origin and the input physical characteristics of the road vehicle.

Further in accordance with the invention there is provided a method of generating one or more routes for a road vehicle, the method comprising:

creating a database of information pertaining to roads that includes geographic data pertaining to road configuration, location and map data for the roads and further includes data indicative of a plurality of characteristics or limits of the roads selected from the group consisting of heights or clearances of bridges, load or weight limits, gradient or angle of incline or decline, obstructions, surface conditions, height, length and width of vehicle limits, number of vehicle wheel limits, size of engine limits, nature of cargo or payload limits, direction of road limits, one way or two way direction limits, left or right hand turn limits, contour of road, ascent and descent limits, paved or not paved surfaces and limits prescribed by rule or regulation;

selecting multiple characteristics or limits of the road vehicle;

comparing the selected characteristics or limits of the road vehicle to the data indicative of the plurality of road characteristics;

determining from the step of comparing road routes having road characteristics that are complementary to or match with the selected characteristics or limits of the road vehicle; and

selecting one or more authorized road routes from the road routes determined in the step of determining to have road characteristics that are complementary to or match with the selected characteristics or limits of the road vehicle.

Such a method preferably further comprises:

displaying the one or more selected authorized road routes to a user on a user interface mounted on the road vehicle in a first visual identifier format.

Such a method preferably further comprises:

determining from the step of comparing road routes that have road characteristics or limits that are not complementary to or do not match the selected characteristics or limits of the road vehicle; and

displaying road routes on the user interface that are determined to have characteristics or limits that are not complementary to or do not match the selected characteristics of the road vehicle in a second visual identifier format that is visually different from the first visual identifier format.

Typically in such a method the step of selecting comprises manually inputting a selected destination position and the characteristics or limits of the road vehicle to the user interface, the user interface communicating the inputted information to a computer that contains the database and instructions for carrying out the steps of comparing, determining and selecting.

In such a method, the method preferably further comprises sensing a physical position of the road vehicle via reception of satellite signals and displaying the physical position of the road vehicle on the user interface.

In another aspect of the invention there is provided a method of generating one or more routes for a road vehicle, the method comprising:

creating a database of information pertaining to roads that includes geographic data pertaining to road configuration, location and map data and further includes data indicative of a plurality of road characteristics or limits selected from the group consisting of heights or clearances of bridges, load or weight limits, gradient or angle of incline or decline, obstructions, surface conditions, height, length and width of vehicle limits, number of vehicle wheel limits, size of engine limits, nature of cargo or payload limits, direction of road limits, one way or two way direction limits, left or right hand turn limits, contour of road, ascent and descent limits, paved or not paved surfaces and limits prescribed by rule or regulation;

selecting one or more characteristics or limits of the road vehicle;

comparing the one or more characteristics or limits of the road vehicle to the data indicative of the plurality of road characteristics;

determining from the step of comparing one or more authorized road routes that have road characteristics that are complementary to or match with the selected characteristics or limits of the road vehicle;

determining from the step of comparing one or more unauthorized roads or road routes that have road characteristics that are not complementary to or do not match with the selected characteristics of the road vehicle; and,

displaying the authorized and unauthorized road routes or selected portions thereof together on a user interface in respective first and second visual identifiers that are different from each other.

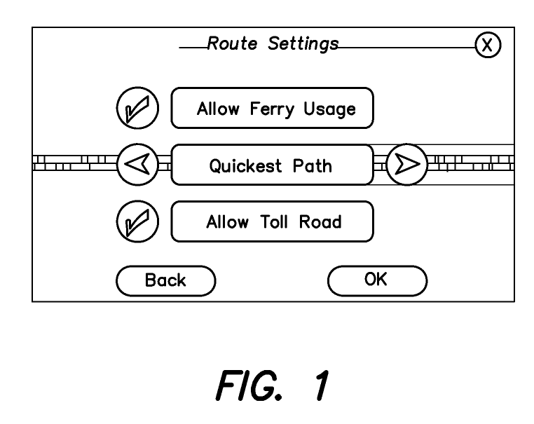

There is shown in FIG. 1, an example of a monitor display of buttons for choosing the initial settings for a GPS guided navigational map for commercial vehicles.

In one embodiment, an apparatus according to the present invention can include an onboard computer which has sufficient memory for storage of a geographic map database for roads. The apparatus can include, a wireless communication system for passing data between the onboard computer and a remote server, an input/output device for providing a user interface between the onboard computer and an operator of the vehicle, and a vehicle sensor for providing motion-related signals to the onboard computer. The onboard computer is programmed to perform the functions of accepting a planned route from the server over the wireless communication system, maintaining a first location estimate of the vehicle using the motion-related signals from the vehicle sensor, and, using the planned route and the first location estimate, providing guidance instructions to the operator through the input/output device. As mentioned the onboard computer component of the invention is in electronic signal communication with a satellite-implemented global positioning system (GPS) transceiver that is in communication with the computer. Accordingly, the computer can receive information from the transceiver that determines the location of the vehicle on the earth's surface.

Additionally, the computer is associated with one or more peripheral devices, including a data entry device such as a keypad. Further, a graphical display screen or monitor is associated with the computer for displaying the preferred route between an operator-selected point of origin and an operator-selected point of destination, based on the vehicle's physical parameters, characteristics or limits.

The keypad, graphical display can be conveniently mounted on the dashboard or on some other suitable surface of the vehicle. In one preferred embodiment, the displays are flat touch screen panel displays such as light emitting diode (LED) displays or liquid crystal displays (LCD).

Thus such an embodiment of the invention also contains the following additional components as part of or attached to it:
1. An external Antenna.
2. A device for generating voice directions—preferably pronounces street names in a variety of languages including but not limited to English, Spanish, French, and Portuguese.
3. MP3 & Video Player—for relaxation during loading or rest time.
4. Bluetooth—Hands Free Port for Cell Phone Use.
5. Automatic reverse camera detection.

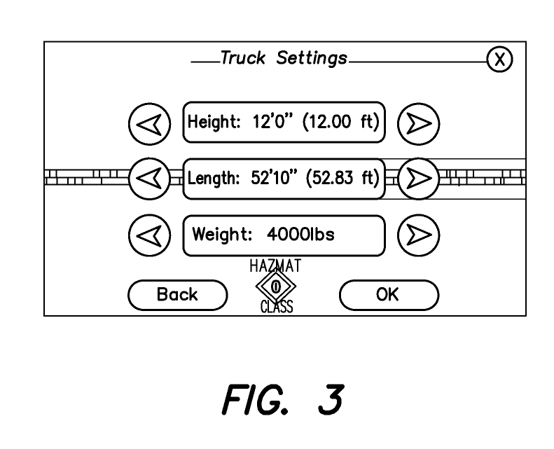

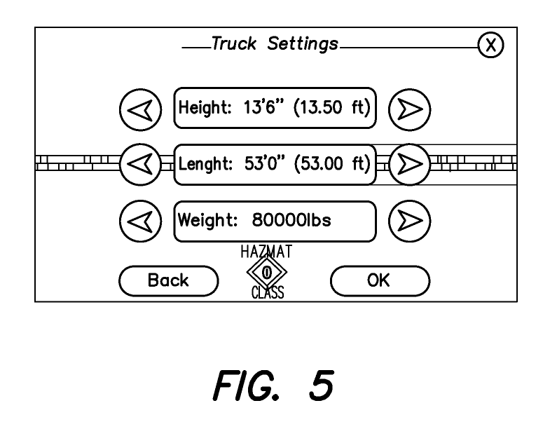

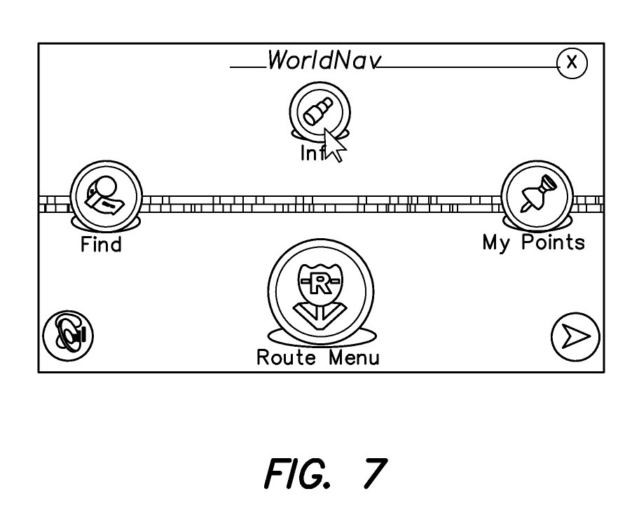

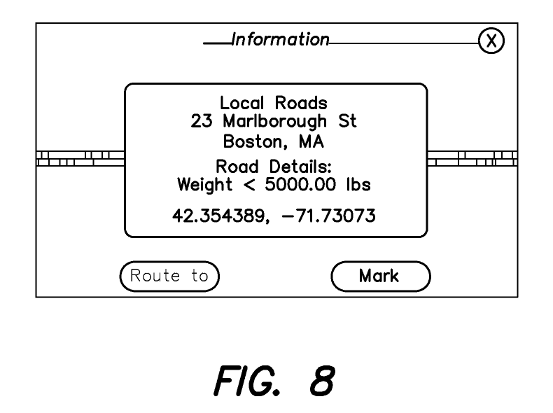

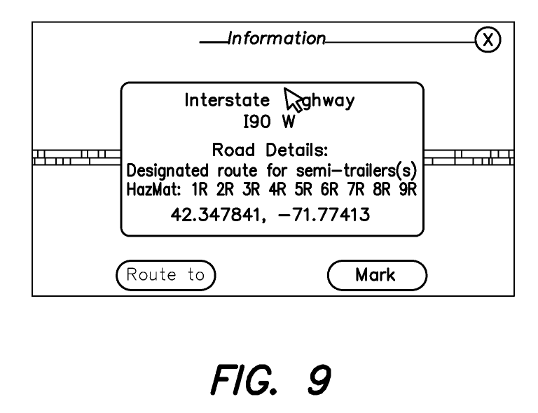

The structures of the modules of the present invention may be embodied in computer program software or in logic circuits. Those skilled in the art will appreciate that FIGS. 1-11 illustrate the structures of computer program code elements that function according to this invention. Manifestly, the invention is practiced in its essential embodiment by a machine component that renders the computer program code elements in a form that instructs a digital processing apparatus (that is, a computer) to perform a sequence of function steps corresponding to those shown in the Figures.

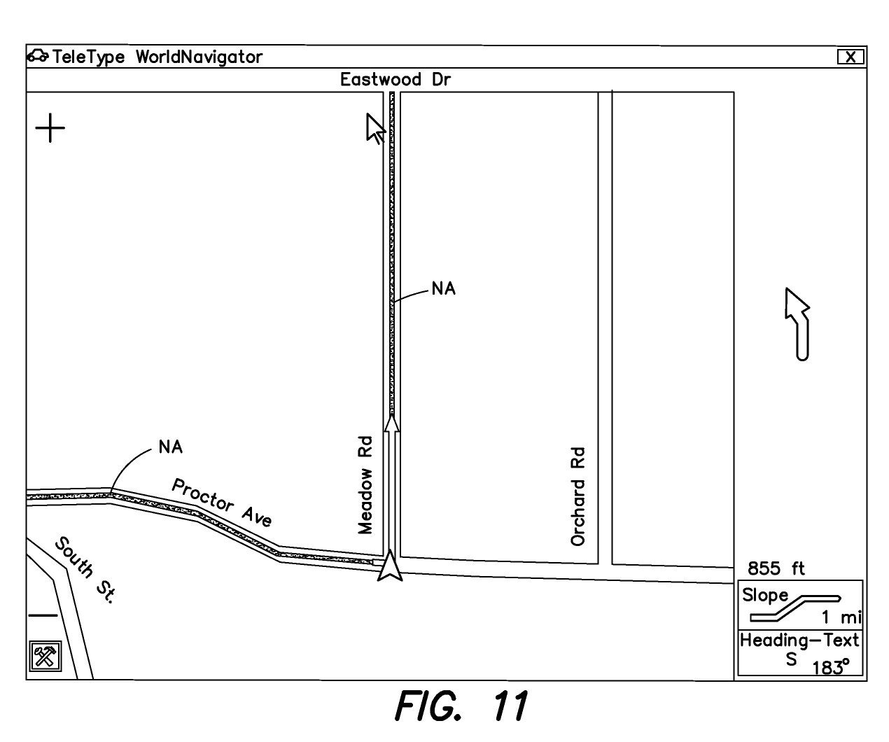

When embodied in software, these instructions may reside on a program storage device including a data storage medium, such as can be found on a computer floppy diskette, on semiconductor devices, on magnetic tape, on optical disks, on a DASD array, on magnetic tape, on a conventional hard disk drive, on electronic read-only memory or on electronic random access memory, or other appropriate data storage device. In an illustrative embodiment of the invention, the computer-executable instructions may be lines of compiled program code such as C.++ language. In any case, apart from the particular computer program storage device (i.e., firmware logic circuits or software) that embodies the modules to establish a program means which embodies logic means that are recognizable by the computer to perform the following method steps:
1. The user can enter the vehicle origin and destination addresses along with the characteristics, limits parameters of the vehicle such as dimension and content on the invention to determine the best route. Alternatively, the vehicle origin can be automatically input to the computer program by a GPS receiving mechanism. Suitable road route properties, characteristics, criteria depend on the vehicle parameters. Suitable criteria of an allowed or authorized route is limited by at least one maximum characteristic of the vehicle such as maximum vehicle height, maximum vehicle width, and maximum vehicle length or maximum number of Category of Hazardous Materials allowed.
2. The program being executed by the computer then determines the best route for ensuring avoidance of restricted areas and can interactively present information to the driver so as to enable the driver/user to make his/her own decisions more informative in route preparation.
3. Based on the input characteristics, limits of the vehicle such as dimension and content of the vehicle, the apparatus of the invention will display allowable or authorized roads that match the characteristics of the vehicle on the map in one color or other visual identifier such as color or texture and additionally generate a map of unauthorized or not allowable roads in the vicinity of the displayed allowable roads. The not allowable roads do not match/complement the characteristics of the vehicle and are displayed in another color or other visual identifier that is different from the allowable road color/identifier in order to warn the driver about roads on which the vehicle is prohibited or not supposed to be travelling.
4. The program preferably includes instructions for computing the best routing and rerouting of the vehicle based in part on matching select vehicle characteristics/criteria to road characteristics to achieve minimum fuel consumption which in turn depends on speed of travel, idling time and elevations that the vehicle will have to encounter and perform.
5. Based on the characteristics of the vehicle such as specified dimension and content of the vehicle, an apparatus according to the invention will display roads on the map with alerting color, texture or other visual identifier to warn driver about roads where location of the vehicle is prohibited.
6. The navigation device of the invention includes program instructions for generating an interactive display of upcoming elevation of the road so that the driver can optimize the speed and gearing before uphill or downhill travel as illustrated in FIG. 11. This helps the vehicle operator to set up speed and gears correctly and optimize fuel consumption of the vehicle.
7. The apparatus of the invention include program instructions that search for a road route to a particular destination address and will check if the destination locates on a section of a road route that can used by a vehicle with specific parameters/characteristics and content.

In another aspect of the invention, there is provided a vehicle information system. The vehicle information system features an in-vehicle system and a centralized server system. The in-vehicle system communicates with the centralized server system using a wireless communication link. In another aspect of the invention the in-vehicle system comprises a computer containing the program that executes the navigation system and the database of information pertaining to the geographic location of the roads and the characteristics, limits or parameters of the roads, such system not requiring wireless communication to a remote centralized computer.

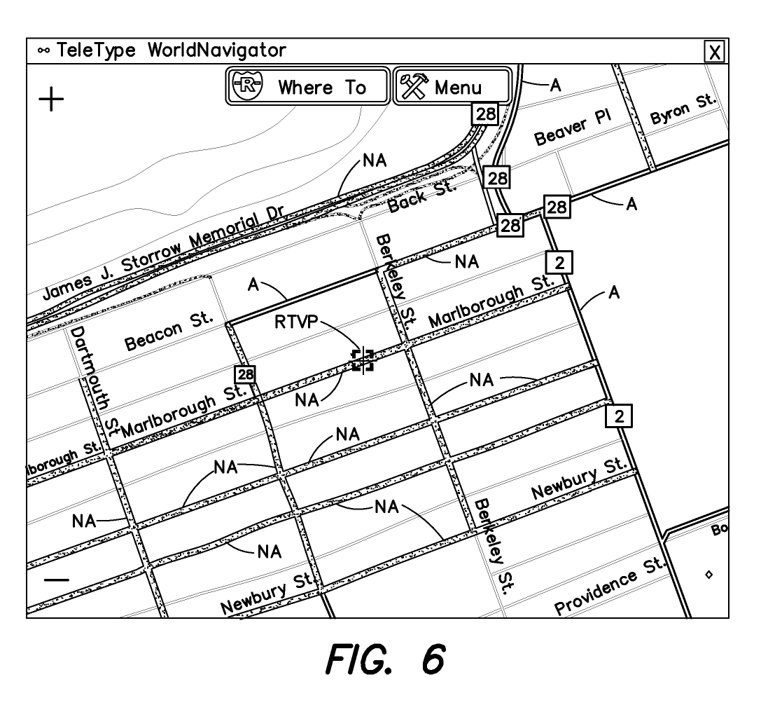

In general, in another aspect, the invention provides a method for guiding a vehicle through a road network from a starting location to a destination, based on the vehicle parameters. The method features transmitting a specification of the destination to either a remote centralized server or to the in-vehicle server or computer, for example by transmitting a street address or an identifier of a point of interest and the vehicle parameters/characteristics. The server determines a route to the specified destination and in the case of a remote server transmits a specification of the route to the vehicle wirelessly; in the case of an in-vehicle system directly from the in vehicle computer processor to the user interface such as a monitor. Roads that do not complement or match the characteristics, limits or criteria of the vehicle are designated/displayed on the user interface in selected visual identifier such as in pink Color. The method includes computing a planned route to a destination location, and in the case of a wireless system sending the planned route to the in-vehicle server and storing the planned route in the server. In the case of a wireless system, the method also includes receiving from the server a specification of a planned route through the road network to the destination as well as receiving from the server a map that includes a specification of the road network in the vicinity of the planned route as depicted in FIGS. 6 to 10.

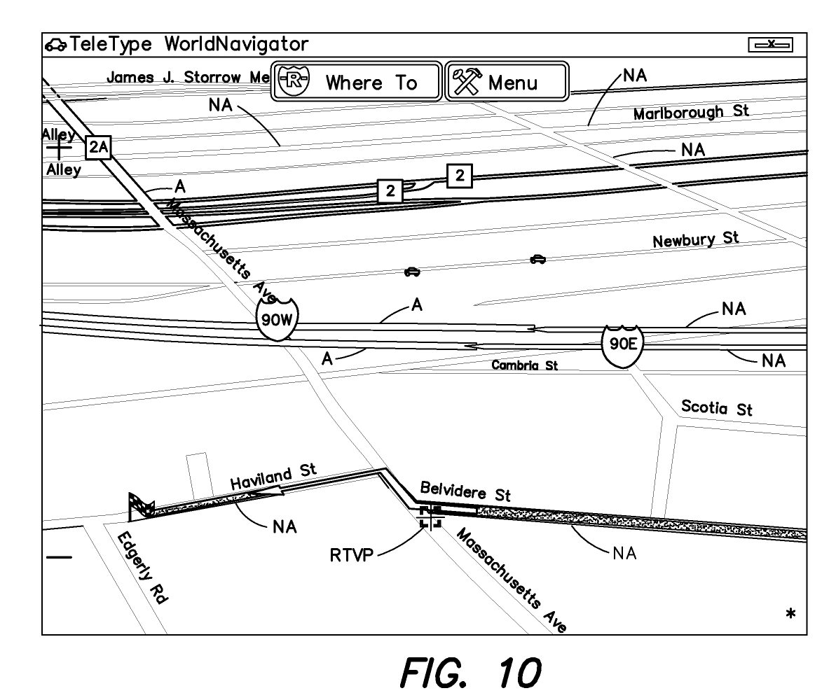

The map can correspond to one or more regions in the immediate vicinity of particular points on the planned route, such as a “corridor” around the planned route, or can comprise a more complex shaped region in the vicinity of the route. The planned route can include specifications for multiple maneuvers to be carried out by the vehicle, and the specification of each maneuver then includes a location of the maneuver. The displayed map can be in the vicinity of the starting location, or in the vicinity of one of the specified maneuvers. The method can also feature tracking the location of the vehicle as shown in FIG. 10. The method can also include displaying the computed map in conjunction with a representation of the planned route, and a location of the vehicle. The displayed map can provide useful information to an operator of a vehicle during difficult maneuvers with turn-by-turn instructions.

The method can include receiving a reference signal from a positioning system, for example receiving signals from GPS satellites, and computing position data related to the location of the vehicle using the received reference signal. For example, the position data can be latitude and longitude estimates, or can be GPS pseudorange measurements. The method can also include transmitting the position data to a server and receiving from the server position correction data. For example, the position correction can be a deviation in latitude and longitude, or can be correction terms to be applied to GPS pseudorange measurements. The method also features determining estimated coordinates of the vehicle including combining data computed from the received reference signal and the position correction data.

The method of the invention can also include repeatedly computing the position data, and determining the estimated coordinates, including combining the position data and the position correction data. The method can also include, subsequent to the interval of time, repeatedly computing the position data and determining estimated coordinates of the vehicle using the position data without using the correction data. The method can also include planning an initial route. The initial route includes an initial set of multiple intermediate points coupled by road segments or portions of complete road route. The planned route is formed from the initial route. For any of the road segments in the initial route for which the difference in locations of the intermediate points bounding that segment is greater than can be specified in the allocated number of bits, the method includes inserting additional intermediate points on that road segment so that the differences between the locations of the adjacent intermediate points can each be specified in the allocated number of bits.

In a preferred embodiment the apparatus of the invention is dedicated to performing operations and functions that are exclusively related to generating road routes. Such a dedicated system typically comprises a readily manually portable housing in/on which is contained and mounted the user interface for enabling the user to input vehicle characteristics/limits/parameters and one or more of the following: (a) a computer or processor having an operating system that enables execution of a program that generates the road routes according to the invention, (b) memory sufficient to store the database of geographic road map and road characteristics/limits data, (c) memory for receiving and communicating the user input vehicle characteristic data to the program, (d) the GPS receiver that receives and sends the satellite position signals to the processor and the user interface.

In such a dedicated system, the operating system that implements the program for calculating the road routes is “embedded” in a permanent memory or storage medium and cannot be modified or accessed by the user or accessed/modified at all without highly specialized equipment if it can be accessed/modified at all. Embedded means stored in a memory or storage medium wherein the information, data, programs or operating system that is stored on such an embedded medium is not accessible or erasable or modifiable by the user. Examples of embedded memory/storage media are EEPROM and ROM memory devices. In any event in such a dedicated device, the operating system is not stored in a conventional hard drive memory as is normally found in laptop and personal computers such hard drive memory media being accessible, erasable and modifiable by the user. The program that calculates the road routes itself is not typically embedded but rather stored on a memory card that is mounted in a suitable slot in/on the portable device. In a typical embodiment, the program that processes receipt of the GPS satellite signals from overhead satellites and generates the RTVP (real time vehicle position) data pertaining to the position of the user's vehicle is also stored in an embedded memory medium, typically on another EEPROM or ROM device that is mounted in/on the portable device together with the embedded memory device in/on which the operating system is stored. The embedded operating system receives the user inputted characteristics/limits data pertaining to the vehicle from a conventional source of memory such as RAM (random access memory) or other memory into which the user has inputted the multiple characteristics/limits that are specific to the user's vehicle. This data (input by the user via the user interface, typically a touch sensitive screen/monitor) is delivered to or read by, together with the instructions of the road route calculating program, the embedded operating system. The program that is stored on the erasable memory card and accessed by the operating system then executes to generate a map of road routes based on the dynamically input multiplicity of parameters peculiar to the vehicle together with the RTVP data (i.e. GPS position data). The RTVP data is generated from the GPS program that is embedded in its own embedded/dedicated memory medium, the embedded GPS program device receiving signals from the GPS satellite system in space. The map that the program in combination with the embedded operating system and GPS data generates includes portions that have unique identifiers for roads/routes that do not match the input characteristics of the vehicle. Thus, in a preferred embodiment where the operating system for the program is embedded, the apparatus is dedicated to generating a map of road routes from dynamically input vehicle data with a route that is calculated to illustrate roads and routes that are not authorized in addition to roads and routes that are authorized and to display both the authorized and not authorized roads and routes (or a portion thereof) together on a user interface (typically a touch sensitive monitor) in different visual identifiers (typically different colors).

In such a dedicated system, typically the operating system as installed does not enable an internet browsing or electronic mail (email) sending, receiving or generation client or program that would otherwise compete with the operation of the processor, the portability of the apparatus and the ease of use of the apparatus. Most preferably in a dedicated device according to the invention, the firmware has been configured to execute navigation as the primary function and the operating system does not offer a multiplicity of other applications normally associated with portable computers such as (but not limited to):

1. an internet browser

2. an email client

3. a word processing program

4. a spreadsheet program

Thus an apparatus according to the invention has a processor that dedicates at least about 80% of its processing power at any given time during operation to the calculation or re-calculation of road routes.

Most preferably the monitor of the dedicated apparatus is touch sensitive and the program provides/generates screen interactive buttons that enables the user to manually input multiple items of vehicle characteristic data to the apparatus by touching selected data input buttons that appear on the screen/monitor.

In accordance with another embodiment of the invention, there is provided, an apparatus for determining a route for a road vehicle for a user comprising:

a database of information pertaining to roads, the information comprising geographic data that includes map, location and configuration data for the roads, the information further comprising data indicative of a plurality of road characteristics or limits that pertain to the roads, the plurality of characteristics or limits being selected from the group consisting of heights or clearances of bridges, load or weight limits, gradient or angle of road incline, obstructions, surface conditions, height, length and width of vehicle limits, number of vehicle wheel limits, size of engine limits, nature of cargo or payload limits, direction of road limits, one way or two way direction limits, left or right hand turn limits, contour of road, ascent and descent limits, paved or not paved surfaces and limits prescribed by governmental rule or regulation;

a program performing a first operation that compares a multiplicity of selected characteristics or limits of the road vehicle to the data indicative of the plurality of road characteristics or limits contained within the database and a second operation that computes one or more authorized road routes for the road vehicle, the second operation having instructions that use the comparison of the first operation to generate one or more authorized road routes having road characteristics that complement or match the selected characteristics of the road vehicle; and

an operating system for the program, the operating system being stored in an embedded memory medium not accessible by the user;

wherein the program, the database of information and the multiplicity of selected characteristics of the vehicle are stored in other memory media;

wherein the embedded memory and the other memory media are mounted in a manually portable housing.

Such an apparatus preferably includes a user interface mounted on the portable housing, the user interface being interconnected to the other memory and having a data input mechanism engageable by the user to input the multiplicity of selected characteristics or limits of the vehicle to the other memory for access by the program.

In such an embodiment, most preferably, the operating system is dedicated to operating the program that performs the first and second operations.

Further in such an embodiment, the apparatus includes a position determining device comprising a position generating program contained within an embedded memory medium that is mounted in or on the portable housing and communicates with the program having the first and second operations.

Further in such an embodiment, the program includes instructions that compute one or more unauthorized road routes or portions of unauthorized road routes having road characteristics that are not complementary to or do not match the selected characteristics or limits of the road vehicle.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

It will be apparent to those skilled in the art that the objects of this invention have been achieved by providing the above invention. However various changes may be made in the structure of the invention without departing from the concept of the invention. Therefore, the scope of the invention is to be determined by the terminology of the following claims and the legal equivalents thereof.

What is claimed is:

1. Apparatus for determining a route for a road vehicle for a user comprising:
a database of information pertaining to roads, the information comprising geographic data that includes map, location and configuration data for the roads, the information further comprising data indicative of a plurality of road characteristics or limits that pertain to the roads, the plurality of characteristics or limits being selected from the group consisting of heights or clearances of bridges, load or weight limits, gradient or angle of road incline, obstructions, surface conditions, height, length and width of vehicle limits, number of vehicle wheel limits, size of engine limits, nature of cargo or payload limits, direction of road limits, one way or two way direction limits, left or right hand turn limits, contour of road, ascent and descent limits, paved or not paved surfaces and limits prescribed by governmental rule or regulation;
a program having a first operation that compares a multiplicity of selected characteristics or limits of the road vehicle to the data indicative of the plurality of road characteristics or limits contained within the database and a second operation that computes one or more authorized road routes for the road vehicle, the second operation having instructions that use the comparison of the first operation to generate one or more authorized road routes having road characteristics that complement or match the selected characteristics or limits of the road vehicle;
a user interface mounted in the road vehicle and interconnected to the program, the user interface communicating data between the program and the user and including a monitor that displays the authorized road routes in one or more first selected visual identifiers to the user according to the instructions; and
a memory interconnected to the user interface and the program, the memory receiving an input of the multiplicity of selected characteristics or limits of the road vehicle from the user interface, the program receiving the multiplicity of selected characteristics or limits from the memory.

2. The apparatus of claim 1 wherein the program includes instructions that compute and display on the monitor one or more unauthorized road routes or portions of unauthorized road routes having road characteristics that are not complementary to or do not match the selected characteristics of the road vehicle, the unauthorized road routes or portions of unauthorized road routes being displayed according to the instructions in one or more second selected visual identifiers that are visually different from the first selected visual identifiers.

3. The apparatus of claim 1 further comprising a position determining device that determines the physical position of the road vehicle in, on or with respect to the geographic database of road configuration, location and map information.

4. The apparatus of claim 1 wherein the user interface includes a device for manually inputting data indicative of one or more of a position of destination, a position of origin and the selected physical characteristics of the road vehicle to the program.

5. The apparatus of claim 3 wherein the position determining device includes an electronic signal receiver that receives electronic position signals from one or more satellites sending electronic position signals from space to the electronic signal receiver, the program being interconnected to the position determining device such that the program dynamically and automatically receives the electronic position signals and includes instructions that dynamically identify the position of the vehicle within the geographic data and display the identified position on the monitor.

6. The apparatus of claim 1 further comprising a computer comprising a processor for carrying out the first and second operations and memory for receiving and storing the data, the computer being physically located remote from the road vehicle and a wireless electronic signal communicating apparatus that communicates signals between the user interface and computer including signals containing results of the first and second operations.

7. The apparatus of claim 1 further comprising a portable computer integrated into a readily manually portable housing together with the user interface, the portable touch or non touch screen computer comprising a processor for carrying out the first and second operations and memory for receiving and storing the data.

8. The apparatus of claim 7 wherein the portable housing includes a position determining device having a receiver that receives electronic position signals from one or more satellites that send electronic position signals from space, the program being interconnected to the position determining device such that the program dynamically and automatically receives the electronic position signals, the program including instructions for dynamically identifying the position of the vehicle within the geographic data and displaying the identified position on the monitor.

9. The apparatus of claim 1 wherein the program includes instructions for computing one or more routes for the road vehicle based on a position of origin and a position of destination.

10. The apparatus of claim 1 wherein the program includes instructions for computing one or more routes that minimize consumption of fuel by the road vehicle relative to other routes.

11. The apparatus of claim 1 wherein the program includes instructions for displaying one or more components of a computed route in selected colors that are indicative of a selected characteristic of the computed route.

12. The apparatus of claim 1 wherein the program includes instructions for automatically re-computing one or more alternate authorized routes for the road vehicle when the road vehicle deviates from a position that differs from a position along the one or more road authorized routes computed in the second operation.

13. The apparatus of claim 5 wherein the program includes instructions for automatically re-computing one or more alternate authorized routes for the road vehicle when the road vehicle deviates from a position that differs from a position along the one or more authorized road routes computed in the second operation.

14. Apparatus for determining a route for a road vehicle for a user comprising:
a database of information pertaining to roads, the information comprising geographic data that includes map, location and configuration data for the roads, the information further comprising data indicative of a plurality of road characteristics or limits that pertain to the roads, the plurality of characteristics or limits being selected from the group consisting of heights or clearances of bridges, load or weight limits, gradient or angle of road incline, obstructions, surface conditions, height, length and width of vehicle limits, number of vehicle wheel limits, size of engine limits, nature of cargo or payload limits, direction of road limits, one way or two way direction limits, left or right hand turn limits, contour of road, ascent and descent limits, paved or not paved surfaces and limits prescribed by governmental rule or regulation;
a program having a first operation that compares a multiplicity of selected characteristics or limits of the road vehicle to the data indicative of the plurality of road characteristics or limits contained within the database and a second operation that computes one or more authorized road routes for the road vehicle, the second operation having instructions that use the comparison of the first operation to generate one or more authorized road routes having road characteristics that complement or match the selected characteristics of the road vehicle; and
wherein the program includes instructions that compute one or more unauthorized road routes or portions of unauthorized road routes having road characteristics that are not complementary to or do not match the selected characteristics or limits of the road vehicle.

15. The apparatus of claim 14 further comprising a monitor interconnected to the program, the program including instructions that:
display the authorized road routes on the monitor in one or more first selected visual identifiers to the user; and,
display the unauthorized road routes or portions of unauthorized road routes on the monitor in one or more second selected visual identifiers that are visually different from the first selected visual identifiers.

16. The apparatus of claim 14 further comprising:
a user interface mounted in the road vehicle and interconnected to the program, the user interface communicating data between the program and the user; and
a memory interconnected to the user interface and the program, the memory receiving an input of the multiplicity of selected characteristics of the road vehicle from the user interface, the program receiving the multiplicity of selected characteristics from the memory.

17. The apparatus of claim 15 further comprising:
a user interface mounted in the road vehicle and interconnected to the program, the user interface including the monitor and communicating data between the program and the user via the monitor; and
a memory interconnected to the user interface and the program, the memory receiving an input of the multiplicity of selected characteristics of the road vehicle from the user via the user interface, the program receiving the multiplicity of selected characteristics from the memory.

18. The apparatus of claim 14 further comprising a position determining device that includes an electronic signal receiver that receives electronic position signals from one or more satellites sending electronic position signals from space to the electronic signal receiver, the program being interconnected to the position determining device such that the program dynamically and automatically receives the electronic position signals and includes instructions that dynamically identify the position of the vehicle within the geographic data and displays the identified position on the monitor.

19. The apparatus of claim 17 wherein the user interface includes a device for manually inputting data indicative of one or more of a position of destination, a position of origin and the selected physical characteristics of the road vehicle to the program, the program including instructions for computing the one or more authorized and unauthorized routes based on one or more of the input position of destination, the input position of origin and the input physical characteristics of the road vehicle.

20. Method of generating one or more routes for a road vehicle, the method comprising:
creating a database of information pertaining to roads that includes geographic data pertaining to road configuration, location and map data and further includes data indicative of a plurality of road characteristics or limits selected from the group consisting of heights or clearances of bridges, load or weight limits, gradient or angle of incline or decline, obstructions, surface conditions, height, length and width of vehicle limits, number of vehicle wheel limits, size of engine limits, nature of cargo or payload limits, direction of road limits, one way or two way direction limits, left or right hand turn limits, contour of road, ascent and descent limits, paved or not paved surfaces and limits prescribed by rule or regulation;
selecting multiple characteristics or limits of the road vehicle;
comparing the selected characteristics or limits of the road vehicle to the data indicative of the plurality of road characteristics;
determining from the step of comparing road routes having road characteristics that are complementary to or match with the selected characteristics or limits of the road vehicle; and
selecting one or more authorized road routes from the road routes determined in the step of determining to have road characteristics that are complementary to or match with the selected characteristics or limits of the road vehicle.

21. The method of claim 20 further comprising:
displaying the one or more selected authorized road routes to a user on a user interface mounted on the road vehicle in a first visual identifier format.

22. The method of claim 21 further comprising:
determining from the step of comparing road routes that have road characteristics or limits that are not complementary to or do not match the selected characteristics or limits of the road vehicle; and
displaying road routes on the user interface that are determined to have characteristics or limits that are not complementary to or do not match the selected characteristics of the road vehicle in a second visual identifier format that is visually different from the first visual identifier format.

23. The method of claim 20 wherein the step of selecting comprises manually inputting a selected destination position and the characteristics or limits of the road vehicle to the user interface, the user interface communicating the inputted information to a computer that contains the database and instructions for carrying out the steps of comparing, determining and selecting.

24. The method of claim 21 further comprising sensing a physical position of the road vehicle via reception of satellite signals and displaying the physical position of the road vehicle on the user interface.

25. Apparatus for determining a route for a road vehicle for a user comprising:
a database of information pertaining to roads, the information comprising geographic data that includes map, location and configuration data for the roads, the information further comprising data indicative of a plurality of road characteristics or limits that pertain to the roads, the plurality of characteristics or limits being selected from the group consisting of heights or clearances of bridges, load or weight limits, gradient or angle of road incline, obstructions, surface conditions, height, length and width of vehicle limits, number of vehicle wheel limits, size of engine limits, nature of cargo or payload limits, direction of road limits, one way or two way direction limits, left or right hand turn limits, contour of road, ascent and descent limits, paved or not paved surfaces and limits prescribed by governmental rule or regulation;
a program having a first operation that compares a multiplicity of selected characteristics or limits of the road vehicle to the data indicative of the plurality of road characteristics or limits contained within the database and a second operation that computes one or more authorized road routes for the road vehicle, the second operation having instructions that use the comparison of the first operation to generate one or more authorized road routes having road characteristics that complement or match the selected characteristics of the road vehicle; and
an operating system for the program, the operating system being stored in an embedded memory medium not accessible by the user;
wherein the program, the database of information and the multiplicity of selected characteristics of the vehicle are stored in other memory media;
wherein the embedded memory and the other memory media are mounted in a manually portable housing.

26. The apparatus of claim 25 further comprising a user interface mounted on the portable housing, the user interface being interconnected to the other memory and having a data input mechanism engageable by the user to input the multiplicity of selected characteristics or limits of the vehicle to the other memory for access by the program.

27. The apparatus of claim 25 wherein the operating system is dedicated to operating the program.

28. The apparatus of claim 25 further comprising a position determining device comprising a position generating program contained within an embedded memory medium that is mounted in or on the portable housing and communicates with the program having the first and second operations.

29. The apparatus of claim 25 wherein the program includes instructions that compute one or more unauthorized road routes or portions of unauthorized road routes having road characteristics that are not complementary to or do not match the selected characteristics or limits of the road vehicle.

30. Method of generating one or more routes for a road vehicle, the method comprising:
creating a database of information pertaining to roads that includes geographic data pertaining to road configuration, location and map data and further includes data indicative of a plurality of road characteristics or limits selected from the group consisting of heights or clearances of bridges, load or weight limits, gradient or angle of incline or decline, obstructions, surface conditions, height, length and width of vehicle limits, number of vehicle wheel limits, size of engine limits, nature of cargo or payload limits, direction of road limits, one way or two way direction limits, left or right hand turn limits, contour of road, ascent and descent limits, paved or not paved surfaces and limits prescribed by rule or regulation;
selecting one or more characteristics or limits of the road vehicle;
comparing the one or more characteristics or limits of the road vehicle to the data indicative of the plurality of road characteristics;
determining from the step of comparing one or more authorized road routes that have road characteristics that are complementary to or match with the selected characteristics or limits of the road vehicle;
determining from the step of comparing one or more unauthorized roads or road routes that have road characteristics that are not complementary to or do not match with the selected characteristics of the road vehicle; and,
displaying the authorized and unauthorized road routes or selected portions thereof together on a user interface in respective first and second visual identifiers that are different from each other.
